(19) United States
(12) Patent Application Publication
(10) Pub. No.: US 2007/0205392 A1
(43) Pub. Date: Sep. 6, 2007

(54) Stabilized and Freeze-Protected Polymer Drag Reducing Agent Suspensions

(75) Inventor: Thomas J. Martin, Bixby, OK (US)

Correspondence Address: MADAN, MOSSMAN & SRIRAM, P.C., 2603 AUGUSTA, SUITE 700, HOUSTON, TX, 77057, US

(73) Assignee: BAKER HUGHES INCORPORATED, Houston, TX (US)

(21) Appl. No.: 11/672,089

(22) Filed: Feb. 7, 2007

Related U.S. Application Data
(60) Provisional application No. 60/771,385, filed on Feb. 8, 2006.

(51) Int. Cl. C09K 5/00

(52) U.S. Cl. 252/70; 252/71

(57) ABSTRACT

A method and composition for a freeze-protected, stabilized polymer drag reducing agent suspension comprises a combination of a drag reducing agent polymer and an aqueous carrier. The carrier comprises a dissolved alcohol, glycol, diol, or glycol ether and a dissolved polysaccharide. The resulting suspension is relatively stable against settling, separation and agglomeration.

### CROSS-REFERENCE TO A RELATED APPLICATION

This non-provisional application claims the benefit of U.S. Provisional Application Ser. No. 60/771,385, filed Feb. 8, 2006.

### BACKGROUND OF THE INVENTION

1. Technical Field

The invention relates to processes for producing polymeric drag reducing agents, and more particularly to processes for producing freeze-protected and stabilized suspensions of polymeric drag reducing agents.

2. Background of the Art

The use of polyalpha-olefins or copolymers thereof to reduce the drag of a liquid hydrocarbon flowing through a conduit, and hence the energy requirements for transporting such hydrocarbon, is well known. These drag reducing agents, or DRAs, have taken various forms in the past, including suspensions of ground polymers to form free-flowing and pumpable mixtures in liquid media.

In general, the DRA polymer may be obtained via solution polymerization of an alpha olefin monomer, or a mixture of olefinic monomers, or from bulk polymerization (i.e., without solvent) of such monomer(s). The DRA polymer may then be subsequently made into particulate form by cutting, chopping, granulating, and/or grinding, at cryogenic or ambient temperatures. Alternatively, it may be precipitated from solution by addition of a non-solvent component. Mixtures of polymer solids from both sources may be used.

Once the polymer DRA is prepared and reduced to appropriate particulate form, it is incorporated with a liquid carrier to form a suspension. In some embodiments the liquid carrier is a non-solvent for the polymer DRA, and its selection may vary widely. Among possible selections are both aqueous and non-aqueous liquids, such as, for example, water and aqueous solutions of various pH and ionic strength; common alcohols and higher alcohols; glycols and diols; glycol ethers; glycol esters; mixtures of these; and the like. A problem that is often encountered, however, is that there is a natural tendency for such suspensions to settle over time, or to separate or agglomerate such that the suspensions no longer maintain a free-flowing and pumpable nature.

One way of addressing this problem has been to include at least a partitioning agent, a wetting agent, and/or a rheology modifier in the suspension. These three components, which are frequently all included, are referred to generally as “suspension aids”. The purpose of the partitioning agent is to physically hold the polymer DRA particle surfaces apart. The purpose of the wetting agent is to wet the polymer DRA surface, and the purpose of the rheology modifier is to increase the viscosity of the liquid carrier to slow down polymer DRA particle settling or rising. In some cases a single ingredient may serve multiple purposes within the suspension aid package. The use of some combinations of materials may be limited by the choice of carrier, and in some cases the effectiveness of suspension aids may also be compromised by the carrier. Additional ingredients may also be included, as necessary, and may include, for example, biocides, corrosion inhibitors, fungicides, and the like.

Where aqueous carriers are selected, one problem that is encountered is that the freezing point of the suspension may be undesirably high. This means that the suspension has limited usage at relatively low temperatures. For this reason freeze protectants such as alcohols, glycols, diols, or glycol ethers may be used to lower the freezing point of the aqueous carrier and provide a greater temperature range for use. However, the addition of alcohols, glycols, diols, or glycol ethers to water may, in many cases, negatively affect the properties of other formulation components and may increase the tendency toward instability, for example, settling, separation agglomeration or gellation.

In view of the above, there is still a need in the art to discover ways to produce both freeze-protected and stabilized polymer DRA suspensions that are convenient and economical and which do not unacceptably suffer from the drawbacks discussed hereinabove.

### SUMMARY OF THE INVENTION

In one aspect, there is provided a method for producing a freeze-protected, stabilized polymer drag reducing agent suspension comprising combining a drag reducing agent polymer and an aqueous carrier comprising a dissolved alcohol, glycol, diol, glycol ether, or combination thereof, and a dissolved polysaccharide, to form a freeze-protected, stabilized drag reducing agent suspension.

In another aspect, there is provided a freeze-protected, stabilized polymer drag reducing agent suspension produced by combining a particulate drag reducing agent polymer and an aqueous carrier comprising a dissolved alcohol, glycol, diol, glycol ether, or combination thereof, and a dissolved polysaccharide, to form a freeze-protected, stabilized polymer drag reducing agent suspension.

In still another aspect there is provided a freeze-protected, stabilized polymer drag reducing agent suspension comprising a particulate drag reducing agent polymer and an aqueous carrier comprising a dissolved alcohol, glycol, diol, glycol ether, or combination thereof, and a dissolved polysaccharide.

The described polymer DRA suspension is, in some embodiments, desirably stabilized against settling, separation and agglomeration and desirably freeze-protected.

### DETAILED DESCRIPTION OF THE INVENTION

In general, described herein are both a method of preparing a freeze-protected, stabilized polymer DRA suspension, and the stabilized suspension prepared thereby. It is both economical and convenient to practice. Among features described is inclusion in the suspension of an aqueous carrier, an alcohol, glycol, diol, or glycol ether that is soluble in the water in the carrier, and a polysaccharide that is also substantially soluble in the water. By “soluble” is meant that, in the case of the alcohol, glycol, diol, or glycol ether, it is soluble, i.e., it may be dissolved, in the aqueous carrier in an amount of greater than about 1 percent, based on the weight of the alcohol, glycol, diol, or glycol ether. In some embodiments such amount is greater than about 50 percent by weight, and in other embodiments such amount is greater than about 75 percent by weight, based on the weight of the alcohol, glycol, diol, or glycol ether. In still other embodiments such amount is greater than about 95 percent by weight, based on the weight of the alcohol, glycol, diol, or glycol ether.

The polysaccharide is defined as “substantially soluble” in water, meaning that, in some non-limiting embodiments, it is soluble, i.e., it may be dissolved and remain dissolved, in the combination of the aqueous carrier and the alcohol, glycol, diol or glycol ether (which combination is referred to as the “total carrier”) in an amount of at least about 80 percent by weight based on the weight of the total carrier. In other non-limiting embodiments it is soluble in an amount of at least about 90 percent by weight and in still other embodiments, of at least about 99 percent by weight, based on the weight of the total carrier. The time period required for this dissolution is based upon practical considerations. If an unacceptably long time period is necessary to achieve the desired level of dissolution, the selection of polysaccharide is probably undesirable, and those wishing to practice the method may wish to consider other polysaccharide selections. The same may be true if the polysaccharide does not remain in solution for a satisfactory period of time under ambient conditions. However, this parameter is not intended to exclude those polysaccharides that may require exposure to non-ambient conditions, for example, conditions of increased temperature or pressure, to achieve a state of dissolution, but which then remain in solution for a satisfactory time period upon a return to ambient conditions.

The dissolved polysaccharide, in combination with the total carrier, results in a rheology modified, freeze-protected product when the polymer DRA is added to form a suspension. This suspension exhibits superior stability, which is defined as resistance to settling, separation and/or agglomeration. As used herein, the term “freeze-protected” refers to having a freezing point that is less than the freezing point of the same material without a “freeze protectant,” by at least about 5 degrees Fahrenheit. A “freeze protectant” is defined as a material which imparts freeze-protection to the composition. “Stable” and “stabilized” are defined as having a relatively consistent viscosity, meaning viscosity variation over time of less than about ±10 percent at the same temperature, based on initial viscosity; and a degree of separation less than about 5 percent, meaning that the volume of material that is not homogeneously combined (as determined visually) is less than about 5 percent of the total material volume.

The polysaccharide is, by definition, a biopolymer, i.e., a polysaccharide that is naturally present in, or used by, certain living organisms. One group of polysaccharides that is generally soluble in the total carrier is the family of so-called “capsular polysaccharides”, which are commonly acidic and have molecular weights on the order of 100-1000 kDa or greater. They are linear and consist of regularly repeating subunits of one to six monosaccharides. They are generally thick, mucous-like materials that are produced by many pathogenic bacteria, for which the capsule cloaks antigenic surface proteins that would otherwise provoke an immune response. These may alternatively be termed as “gums”, which are colloidal polysaccharide substances of biogenic origin that are thick or gelatinous when combined with water. However, because not all of these gums are soluble in the total carrier, they are not all comprehended within the scope hereof, as further discussed hereinbelow.

One non-limiting example of included gums is diutan, also referred to as diutan gum, which is heteropolysaccharide S-657, prepared by fermentation of a suitable nutrient medium (i.e., pure culture fermentation) with a strain of Sphingomonas sp. ATCC 53159, which is a new strain of Xanthomonas campestris. Diutan is composed principally of carbohydrate, about 12 percent protein and about 7 percent (calculated as O-acetyl) acyl groups. The carbohydrate portion contains about 19 percent glucaronic acid, and the neutral sugars rhamnose and glucose are in the approximate molar ratio of 3:2. Details of its structure may be found in an article by Diltz et al., “Location of O-acetyl groups in S-657 using the reductive-cleavage method”, Carbohydrate Research 331 (2001) 265-270, which is incorporated herein by reference in its entirety. Further discussion of preparation of diutan may be found in U.S. Pat. No. 5,175,278, which is also incorporated herein by reference in its entirety. It is a member of the so-called gellan family of polysaccharides.

Similar useful gums include other members of the gellan family. Such include, for example, gellan itself (also called polysaccharide S-60); welan (polysaccharide S-130), polysaccharide S-88, rhamsan (polysaccharide S-194), polysaccharide S-198, polysaccharide NW11, and derivatives and mixtures thereof. These materials are generally referred to as “sphingans”, after the genus name of the organism producing them. Further description and discussion of these materials may be found in U.S. Pat. No. 5,401,659, which is incorporated herein by reference in its entirety. For convenience, these materials will be referred to hereinafter without appending the unnecessary “gum” designation.

Useful polysaccharides are also defined by their ability to impart pseudoplasticity when combined with water and the selected alcohol, glycol, diol or glycol ether. This means that the viscosity of the total carrier in which they are used will increase and decrease virtually instantaneously upon removal and application, respectively, of shear forces. The result is liquids that flow readily but are capable of suspending any solid materials, which in non-limiting embodiments may be the comminuted DRA polymer, when flow is temporarily or permanently halted. While there are other biopolymers that are soluble in water alone, and may in some cases impart pseudoplasticity thereto, these may precipitate out of solution or otherwise fail to impart such pseudoplasticity when alcohols, glycols, diols, or glycol ethers are also included in a proportion above a certain threshold. Examples of these biopolymers, which are thus excluded herefrom where pseudoplasticity is not achieved and/or where precipitation occurs, include gums such as xanthan and guar, carrageenan, substituted cellulosics, modified starches and the like.

The proportion of the polysaccharide to the total carrier is, in some embodiments, at least about 1:100000, i.e., 0.001 percent of the polysaccharide, by weight, based on the total carrier. In other non-limiting embodiments, it is at least about 0.01 by weight, and in still other non-limiting embodiments it is from about 0.04 by weight to about 0.12 by weight. Any combination or mixture of suitable polysaccharides may also be selected, and the total proportion of such combination may fall within the limits given hereinabove.

Non-limiting examples of useful alcohols, glycols, diols, or glycol ethers include those that generally contain a hydroxyl group or multiple hydroxyl groups. Without wishing to limit the selection of useful materials in any way, but only to supply a hypothesis as to mechanism, it may be that some materials having hydroxyl groups operate to disrupt the bonding between water molecules at low temperatures, which may be the factor resulting in or imparting freeze-protection. Such alcohols, glycols, diols, or glycol ethers may be selected from, in non-limiting embodiments, methanol, ethanol, propanol, isopropanol, butanol, ethylene glycol, propylene glycol, butylene glycol, hexylene glycol, diethylene glycol, dipropylene glycol, triethylene glycol, tripropylene glycol, propylene glycol methyl ether, dipropylene glycol methyl ether, tripropylene glycol methyl ether, propylene glycol propyl ether, dipropylene glycol propyl ether, tripropylene glycol propyl ether, propylene glycol butyl ether, dipropylene glycol butyl ether, tripropylene glycol butyl ether, propylene glycol phenyl ether, dipropylene glycol dimethyl ether, diethylene glycol ethyl ether, diethylene glycol methyl ether, diethylene glycol butyl ether, diethylene glycol hexyl ether, ethylene glycol propyl ether, ethylene glycol butyl ether, ethylene glycol hexyl ether, triethylene glycol methyl ether, triethylene glycol ethyl ether, triethylene glycol butyl ether, ethylene glycol phenyl ether, ethylene glycol ethyl ether, mixtures thereof, and the like.

The proportion of alcohol, glycol, diol, or glycol ether to water is, in some embodiments, at least about 1:100, i.e., 1 percent of the alcohol, glycol, diol or glycol ether by volume, based on total aqueous carrier volume. In other non-limiting embodiments, it is from about 20 to about 80 percent by volume. Any combination or mixture of alcohols, glycols, diols, and/or glycol ethers may also be selected, and the total proportion of such combination may fall within the limits given hereinabove.

Appropriate levels of dissolution of the polysaccharide may be confirmed both visually, as to appearance of viscosity and pseudoplastic behavior, and by actual measurement of viscosity. For example, when the polysaccharide is dissolved in an agitated aqueous carrier further containing a dissolved alcohol, glycol, diol, or glycol ether, the polysaccharide solution thus formed will desirably become noticeably pseudoplastic, or “visco-elastic”, over time. This property can be observed visually simply by momentarily stopping the agitation. As the rotation of the polysaccharide solution slows, and then stops, it should briefly recoil in the opposite direction for a short distance. This brief recoil upon removal of the shear forces provided by agitation clearly indicates pseudoplasticity. It is believed that the pseudoplastic nature of the polysaccharide solution that keeps the polymer DRA particles suspended when they are added to form the suspension.

Once the aqueous carrier, comprising both dissolved polysaccharide and dissolved alcohol, glycol, diol, or glycol ether, has been prepared as described, it is ready for addition of at least the polymer DRA to complete formation of a freeze-protected, stabilized polymer DRA suspension. The polymer DRA's are, in some embodiments, ultra-high molecular weight poly alpha olefins that have been formed by polymerization of a selected alpha olefin monomer or combinations of alpha olefin monomers. By “ultra-high molecular weight” is meant polymers having a number average molecular weight greater than about 1 million, and in some embodiments from about 20 million to about 35 million, or higher. This polymerization may be either a solution polymerization, wherein the polymer is precipitated from the solution via addition of a non-solvent component, or a bulk polymerization wherein no solvent is included.

The polymer DRA is desirably added to the liquid carrier in a comminuted form, and in some non-limiting embodiments, in a relatively highly comminuted form. For example, the polymer DRA may be first granulated to relatively large particulate form, followed by grinding to further reduce particle size. The granulation and grinding can be done at elevated, ambient or cryogenic temperatures by various mechanical processes. In some embodiments the particle size at the point of dispersion in the liquid carrier is desirably less than about 1 mm in diameter, and in other embodiments it is less than about 600 microns in diameter. Such small particle size helps, in itself, to maintain the suspension of the polymer DRA and also increases the rapidity of dispersion throughout the stream into which the polymer DRA suspension will be injected and wherein drag reduction is desired.

The polymer DRA may be added while the liquid carrier is at any temperature wherein the dissolution of the polysaccharide may be maintained. In many non-limiting embodiments, ambient conditions may be employed.

While the above components are sufficient to form a stabilized polymer DRA suspension, it is optionally possible to include further components therein. Such additional component(s) may be added either before, concurrently with, or after addition of the particulate polymer DRA. Such additional components may include, for example, partitioning agents, and/or wetting agents, which may in some cases be desirable to further enhance their imparted properties in a given suspension. Such enhancement may be desirable depending upon all of the variables of a given system, including selection of each component of the suspension, the constituency and properties of the stream in which drag will be reduced, type of pumping equipment being used, desired flow rate, and the like. Materials known in the art to be useful for each of the types of additives may be used. For example, in certain non-limiting embodiments, one or more additional partitioning agents may be selected from the group consisting of fatty acid waxes, stearate salts, ethyoxylate waxes, stearamides, polyolefin homopolymers and copolymers of various densities; oxidized polyethylene; polystyrene and copolymers; carbon black and graphites; precipitated and fumed silicas; natural and synthetic clays and organo-clays; aluminum oxides; talc; boric acid; polyanhydride polymers; magnesium, calcium and barium phosphates, sulfates, carbonates and oxides; mixtures thereof; and the like.

Additional wetting agents may, in some exemplary and non-limiting embodiments, be selected from the group consisting of fatty acid waxes, magnesium stearate, calcium stearate, stearamide, ethylene bis stearamide, nonyl phenol and nonyl phenol ethoxylates, and laureth carboxylic acid, as well as commercially available surfactants such as TWEEN™, SPAN™, BRIJ™, and MYRIJ™. These surfactants are available from Uniqema. Cationic and anionic surfactant types are of use also, such as, for example, cetyltrimethyl-ammoniumbromide, sodium dodecyl sulfate, and sodium alkylbenzene sulfonic acid. Some of these additives serve multiple purposes, e.g., both wetting and partitioning.

Additional formulation ingredients, unrelated to suspension stability and freeze protection, may, in some exemplary and non-limiting embodiments, be selected from the group consisting of preservatives, biocides, fungicides, algicides, mold inhibitors, corrosion inhibitors, scale inhibitors, colorants, dyes, mixtures thereof, and the like.

Relative proportions of all of the polymer DRA suspension constituents will, naturally, have an effect upon the final properties, including but not limited to stability to settling, separation and/or agglomeration, of the polymer DRA suspension. While a wide range of proportions may be employed according to the desirable properties of the final suspension, it has been found that, in certain embodiments, a ratio of polymer DRA to overall suspension ranging from about 10 to about 40 percent by weight is effective, while in other embodiments a ratio of polymer DRA to pre-treated dispersion may range from about 17 to about 26 percent by weight. Where additional partitioning agent is to be included it may be, in certain non-limiting embodiments, in the range of from about 0.01 to about 20 percent by weight, as compared to the overall suspension. Additional wetting agent may, in certain non-limiting embodiments, range from about 0.1 to about 2.0 percent by weight, as compared to the overall suspension.

Once all constituents of the final suspension have been combined, and in some embodiments during such combination, appropriate mixing is desirable. Such may be carried out using any method and/or means known to those skilled in the art. The goal of mixing is desirably a relatively high level of homogenization, which serves to enhance consistency in the drag reducing performance of the product, and to reduce the occurrence of settling, separation and/or agglomeration later by ensuring uniformity in the presence of each component such that partitioning and wetting actions are optimized. In some embodiments such mixing may be accomplished by use of a standard fixed blade agitator or high-shear impeller in a drum, tank or vessel for a time of from about 0.5 to about 4 hours at ambient temperatures.

The final suspension is, in some embodiments, a highly uniform polymer DRA suspension that is ready for shipment, storage and/or use for drag reduction in a variety of streams such as hydrocarbons, including, for example, crude oil, heating oils, liquefied natural gas, jet fuel, kerosene, refined gasoline, and diesel fuel. It may be highly stable against settling, separation and/or agglomeration, even when stored for times exceeding six months and under a variety of conditions ranging from, in some non-limiting embodiments, extreme cold (for example, as low as about −40° F.) to extreme heat (for example, as high as about 120° F.).

In use, the suspension is typically used in a proportion, based on weight of the hydrocarbon stream, of from about 1 ppm to about 250 ppm. However, in many embodiments it is incorporated into the hydrocarbon stream in a proportion of from about 10 ppm to about 80 ppm, based on weight of the hydrocarbon stream as a whole.

The following examples are included herein for illustrative purposes only, and are not intended to be, nor should they be construed as being, indicative in any way of the scope hereof. Those skilled in the art will appreciate that many modifications may be made without departing from the spirit and scope thereof, as defined in the appended claims. For example, the identity, nature and exact proportions of polysaccharide, aqueous carrier, alcohol, glycol, diol, or glycol ether, polymer DRA, and additives such as partitioning agents, wetting agents, biocides, and the like; times, temperatures and degree of polysaccharide dissolution; equipment used to prepare any component or the suspension as a whole; and the like; may also be varied while remaining within the scope hereof.

### EXAMPLES

### Example 1

About 968 lb of a precipitated DRA polymer cake made from poly alpha olefin polymer DRA material, containing about 52percent by weight of dipropylene glycol monomethyl ether, is added to about 1095 lb water to form a suspension. The water contains about 1.5 lb of dissolved diutan and about 16 lb of dipropylene glycol. Other ingredients include minor quantities of a biocide; a partitioning agent wax used within the range of about 0.1 to about 20 percent of the total suspension weight; and a wetting agent within the range of about 0.1 to about 2.0 percent of the total suspension weight. No adjustments are made to control pH. The combination is then mixed using a dispersion-type mixer until visually homogeneous.

The final suspension viscosity is about 1000-1500 centipoise (cP). The suspension is stable toward separation after sitting for several weeks, and exhibits a stable viscosity throughout that time period of 1000-1500 cP, as measured using temperature correction with a Brookfield DV-II+ viscometer using a “T-A” spindle at 20 rpm (helical path) at ambient temperature. The freezing point of the suspension is found to be about 12° F., and the pH is between about 8 and 9.

### Example 2

A 301 g quantity of a precipitated DRA polymer cake made from poly alpha olefin polymer and a stearate wax, and containing about 45 percent by weight of a mixture of propylene glycol monomethyl ether, tripropylene glycol monomethyl ether, and higher oligomers of the glycol monomethyl ether, is added to 210 g of water containing about 0.6 g welan dissolved therein. An additional 182 g of ethylene glycol is added to this mixture, which is then mixed using a dispersion-type mixer for about 10 minutes. No adjustments are made to control pH. The suspension viscosity is initially 2800 cP and displays a fluid character and no separation after 11 days during which it stands, non-agitated, at ambient temperatures. The suspension is not frozen after storing at temperatures varying between about 0° F. and ambient for a period of about 24 hours, and the pH remains between 8 and 9.

### Example 3

A 378 g quantity of a precipitated DRA polymer cake made from poly alpha olefin polymer and a stearate wax, containing about 55 percent by weight of an alkaline mixture of isomers of dipropylene glycol monomethyl ether, is added to 193 g of water containing about 0.6 g diutan dissolved therein. An additional 126 g of ethylene glycol is added to this mixture, which is then mixed using a dispersion-type mixer for about 10 minutes. No adjustments are made to control pH. The resulting suspension has an initial viscosity of about 2680 cP and displays a fluid character and no separation after 11 days, during which it stands, non-agitated, at ambient temperatures. The suspension does not freeze when stored at temperatures varying between about 0° F. and ambient for about 24 hours, and the pH remains between 8 and 9.

### Example 4 (Comparative)

A 300 g quantity of a precipitated DRA polymer cake made from poly alpha olefin polymer DRA material, containing about 56 percent by weight of dipropylene glycol monomethyl ether, is added to 251 g of water containing dissolved xanthan at 0.35 percent by weight. The combination is then mixed using a dispersion-type mixer for about 10 minutes. The resulting suspension is fluid at first, but becomes a semi-solid mass in the shape of the container after sitting undisturbed for only 18 hours.

### Example 5 (Comparative)

A 364 g quantity of a precipitated DRA polymer cake made from poly alpha olefin copolymer DRA material, containing about 45 percent by weight of dipropylene glycol monomethyl ether, is added to 299 g tap water containing 3 g of guar dissolved therein. The combination is then mixed using a dispersion-type mixer for about 5 minutes. Within minutes, the polymer DRA solids separate from the aqueous carrier, creating a visually inhomogeneous mixture.

What is claimed is:

1. A method for producing a freeze-protected, stabilized polymer drag reducing agent suspension comprising combining a drag reducing agent polymer; and an aqueous carrier comprising a non-solvent for the polymer selected from the group consisting of a dissolved alcohol, glycol, diol, glycol ether, and combinations thereof, and a dissolved polysaccharide; to form a stabilized drag reducing agent suspension.

2. The method of claim 1 wherein the drag reducing agent polymer is a poly alpha olefin.

3. The method of claim 1 wherein the dissolved alcohol, glycol, diol, or glycol ether is selected from the group consisting of methanol, ethanol, propanol, isopropanol, butanol, ethylene glycol, propylene glycol, butylene glycol, hexylene glycol, diethylene glycol, dipropylene glycol, triethylene glycol, tripropylene glycol, propylene glycol methyl ether, dipropylene glycol methyl ether, tripropylene glycol methyl ether, propylene glycol propyl ether, dipropylene glycol propyl ether, tripropylene glycol propyl ether, propylene glycol butyl ether, dipropylene glycol butyl ether, tripropylene glycol butyl ether, propylene glycol phenyl ether, dipropylene glycol dimethyl ether, diethylene glycol ethyl ether, diethylene glycol methyl ether, diethylene glycol butyl ether, diethylene glycol hexyl ether, ethylene glycol propyl ether, ethylene glycol butyl ether, ethylene glycol hexyl ether, triethylene glycol methyl ether, triethylene glycol ethyl ether, triethylene glycol butyl ether, ethylene glycol phenyl ether, ethylene glycol ethyl ether, and mixtures thereof.

4. The method of claim 1 wherein the polysaccharide is selected from the group consisting of gums of the gellan family.

5. The method of claim 4 wherein the polysaccharide is selected from the group consisting of diutan, gellan, welan, polysaccharide S-88, rhamsan, polysaccharide S-198, polysaccharide NW11, and derivatives and mixtures thereof.

6. The method of claim 1 wherein the aqueous carrier further comprises additives selected from the group consisting of partitioning agents, wetting agents, biocides, fungicides, corrosion inhibitors, preservatives, algicides, mold inhibitors, scale inhibitors, colorants, dyes and mixtures thereof.

7. The method of claim 6 wherein the additives are added to the aqueous carrier before, concurrently with, or after the aqueous carrier, alcohol, glycol, diol, or glycol ether, and polysaccharide are combined.

8. The method of claim 1 wherein the polymer drag reducing agent suspension is freeze-protected and stabilized against settling, separation, agglomeration, or a combination thereof.

9. A freeze-protected, stabilized polymer drag reducing agent suspension produced by combining a particulate drag reducing agent polymer; and an aqueous carrier comprising a non-solvent for the polymer selected from the group consisting of a dissolved alcohol, glycol, diol, glycol ether and combinations thereof, and a dissolved polysaccharide; to form a stabilized polymer drag reducing agent suspension.

10. The suspension of claim 9 wherein the drag reducing agent polymer is a poly alpha olefin.

11. The suspension of claim 9 wherein the dissolved alcohol, glycol, diol, or glycol ether is selected from the group consisting of methanol, ethanol, propanol, isopropanol, butanol, ethylene glycol, propylene glycol, butylene glycol, hexylene glycol, diethylene glycol, dipropylene glycol, triethylene glycol, tripropylene glycol, propylene glycol methyl ether, dipropylene glycol methyl ether, tripropylene glycol methyl ether, propylene glycol propyl ether, dipropylene glycol propyl ether, tripropylene glycol propyl ether, propylene glycol butyl ether, dipropylene glycol butyl ether, tripropylene glycol butyl ether, propylene glycol phenyl ether, dipropylene glycol dimethyl ether, diethylene glycol ethyl ether, diethylene glycol methyl ether, diethylene glycol butyl ether, diethylene glycol hexyl ether, ethylene glycol propyl ether, ethylene glycol butyl ether, ethylene glycol hexyl ether, triethylene glycol methyl ether, triethylene glycol ethyl ether, triethylene glycol butyl ether, ethylene glycol phenyl ether, ethylene glycol ethyl ether, and mixtures thereof.

12. The suspension of claim 9 wherein the polysaccharide is selected from the group consisting of diutan, gellan, welan, polysaccharide S-88, rhamsan, polysaccharide S-198, polysaccharide NW11, and derivatives and mixtures thereof.

13. The suspension of claim 9 wherein the aqueous carrier further comprises additives selected from the group consisting of partitioning agents, wetting agents, biocides, fungicides, corrosion inhibitors, preservatives, algicides, mold inhibitors, scale inhibitors, colorants, dyes and mixtures thereof.

14. The suspension of claim 14 wherein the polymer drag reducing agent is freeze-protected and stabilized against settling, separation, agglomeration, or a combination thereof.

15. A hydrocarbon stream comprising the suspension of claim 9.

16. A freeze-protected, stabilized polymer drag reducing agent suspension comprising a particulate drag reducing agent polymer; and an aqueous carrier comprising a non-solvent for the polymer selected from the group consisting of a dissolved alcohol, glycol, diol, glycol ether, and combinations thereof, and a dissolved polysaccharide.

17. The suspension of claim 16 further comprising additives selected from the group consisting of partitioning agents, wetting agents, biocides, fungicides, corrosion inhibitors, preservatives, algicides, mold inhibitors, scale inhibitors, colorants, dyes and mixtures thereof.

18. The suspension of claim 16 being stabilized against settling, separation, agglomeration, or a combination thereof.

19. The suspension of claim 16 where the dissolved alcohol, glycol, diol, or glycol ether is selected from the group consisting of methanol, ethanol, propanol, isopropanol, butanol, ethylene glycol, propylene glycol, butylene glycol, hexylene glycol, diethylene glycol, dipropylene glycol, triethylene glycol, tripropylene glycol, propylene glycol methyl ether, dipropylene glycol methyl ether, tripropylene glycol methyl ether, propylene glycol propyl ether, dipropylene glycol propyl ether, tripropylene glycol propyl ether, propylene glycol butyl ether, dipropylene glycol butyl ether, tripropylene glycol butyl ether, propylene glycol phenyl ether, dipropylene glycol dimethyl ether, diethylene glycol ethyl ether, diethylene glycol methyl ether, diethylene glycol butyl ether, diethylene glycol hexyl ether, ethylene glycol propyl ether, ethylene glycol butyl ether, ethylene glycol hexyl ether, triethylene glycol methyl ether, triethylene glycol ethyl ether, triethylene glycol butyl ether, ethylene glycol phenyl ether, ethylene glycol ethyl ether, and mixtures thereof.

20. The suspension of claim 16 wherein the polysaccharide is selected from the group consisting of diutan, gellan, welan, polysaccharide S-88, rhamsan, polysaccharide S-198, polysaccharide NW11, and derivatives and mixtures thereof.

21. A hydrocarbon stream comprising the suspension of claim 16.
